(19) United States
(12) Patent Application Publication
(10) Pub. No.: US 2006/0106133 A1
(43) Pub. Date: May 18, 2006

(54) Ink-jet ink and recording method utilizing the same

(75) Inventors: Yoshinori Tsubaki, Tokyo (JP); Masaki Nakamura, Tokyo (JP); Hirotaka Iijima, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC., Tokyo (JP)

(21) Appl. No.: 11/271,427

(22) Filed: Nov. 10, 2005

(30) Foreign Application Priority Data
Nov. 18, 2004 (JP) JP2004-334415
Jan. 26, 2005 (JP) JP2005-017881

(51) Int. Cl. C03C 17/00; C09D 11/00

(52) U.S. Cl. 523/160; 523/161

(57) ABSTRACT

An ink-jet ink containing: (i) a colorant; (ii) Solution A containing water, a water miscible organic solvent and an amphiphilic polymer, wherein Solution A satisfies all of the following requirements: Scheme (1) A1>A2; Scheme (2) B1>B2 Scheme (3) A1/B1>1 provided that A1 is a Stokes diameter of the amphiphilic polymer in Solution A; B1 is an optical scattering diameter of the amphiphilic polymer in Solution A; A2 is a Stokes diameter of the amphiphilic polymer in Solution A after a content of water in Solution A is evaporated by an amount of 10 to 30 wt % from an initial Solution A; and B2 is an optical scattering diameter of the amphiphilic polymer in Solution A after a content of water in Solution A is evaporated by an amount of 10 to 30 wt % from an initial Solution A.

This application is based on Japanese Patent Application No. 2004-334415 filed on Nov. 18, 2004 and No. 2005-017881 filed on Jan. 26, 2005 in Japanese Patent Office, the entire contents of which are hereby incorporated by reference.

### TECHNICAL FIELD

The present invention relates to an ink-jet ink and a recording method utilizing the same, and particularly to an ink-jet ink; which has been improved in decap resistance (or clogging resistance), as well as is excellent in feathering resistance, bleeding resistance and fixing capability, and provides high image density, at the time of recording on a water absorptive recording medium; and a recording method utilizing the same.

### BACKGROUND

An ink-jet recording method enables highly precise image recording with a relatively simple apparatus and has been rapidly prevailing in various fields. Further, the application purposes are various and employed is a recording medium or an ink-jet ink suitable for each purpose. However, in an ink-jet image recording system requiring exclusive paper, there have been problems of such as limitation of a recording medium usable and increasing cost of exclusive paper utilized.

In view of these problems, development of a printing method capable of recording high quality images on various types of recording media has been demanded, and for example, as for ordinary paper, desired have been improvements concerning characteristics of irregular ink bleeding along the paper fiber, deficient surface density due to so-called feathering or print through of ink, and white background deterioration of the back surface; while as for art paper and coated paper which are slightly water-absorptive, there were problems that mottled image unevenness between the same color due to insufficient ink absorbability, so-called beading and color contamination between multi colors, that is, bleeding have to be depressed.

On the other hand, as for an ink image recorded on a recording medium, there have been problems of durability of an image, particularly, water resistance in the case of employing dye as a coloring material, and an anti-abrasion capability in the case of employing pigment as a coloring material.

Against above each problem, proposed has been a hot melt type ink-jet recording method, in which, employing a hot melt type ink composition comprising a material such as wax which is solid at room temperature, said wax is liquefied by such as heating and ejected with application of some energy and cooled to be a solid while being adhered onto a recording medium, whereby recording dots are formed.

Since this hot melt type ink is solid at room temperature, contamination in handling is avoided and there is essentially no ink evaporation amount at the time of being fused, resulting in no clogging at a nozzle portion. Further, the ink is immediately solidified after adhering to a recording medium to cause little color bleeding. As such hot melt type ink, proposed have been ink compositions which provide excellent print quality regardless of paper property (for example, refer to patent literatures 1 and 2). However, in a recording method utilizing such hot melt type ink, printed dot causes swelling to deteriorate print quality as well as there is a problem of poor abrasion resistance.

While, as ink-jet recording ink curable by ultraviolet ray exposure, disclosed has been ink-jet recording ink which employs epoxy modified acryl resin and urethane modified resin as a binder and pigment having a particle size of not more than 5 μm as a coloring component (for example, refer to patent literature 3). However, there have been problems that the printed dot swells to make formation of a high quality image difficult, as well as the curing degree is insufficient with pigment type ink having insufficient transmission of ultraviolet rays resulting in poor abrasion resistance.

On the other hand, proposed has been an ink-jet recording ink in which moisture-resistance and anti-abrasion capability are improved by incorporation of organic latex in the ink (for example, refer to patent literatures 4 and 5). However, there has been a problem that, when a sufficient amount of such organic latex to fix pigment is incorporated in ink, viscosity increase of ink becomes significant due to local drying of ink in the neighborhood of the ejection outlet of an ink-jet head, resulting in making stable ink ejection difficult because of clogging at a nozzle portion or at a filter portion.

[Patent literature 1] U.S. Pat. No. 4,391,369

[Patent literature 2] U.S. Pat. No. 4,484,948

[Patent literature 3] U.S. Pat. No. 4,228,438

[Patent literature 4] Examined Japanese Patent Application Publication No. 60-32663

[Patent literature 5] JP-A No. 4-18462 (hereinafter, JP-A refers to Japanese Patent Publication Open to Public Inspection).

### SUMMARY

This invention has been made in view of the above problems, and an object is to provide an ink-jet ink; which has been improved in decap resistance as well as is excellent in feathering resistance, bleeding resistance and fixing capability, and provides high image density, at the time of recording on a water absorptive recording medium; and a recording method utilizing the same.

The above-described object of the present invention can be achieved by the following structures.

(1) An aspect of the present invention includes an ink-jet ink comprising:

(i) a colorant;

(ii) Solution A comprising water, a water miscible organic solvent and an amphiphilic polymer,

wherein Solution A satisfies all of the following requirements represented by Schemes (1) to (3):
Scheme (1) A1>A2
Scheme (2) B1>B2
Scheme (3) A1/B1>1

provided that A1 is a Stokes diameter of the amphiphilic polymer in Solution A; B1 is an optical scattering diameter of the amphiphilic polymer in Solution A; A2 is a Stokes diameter of the amphiphilic polymer in Solution A after a content of water in Solution A is evaporated by an amount of 10 to 30 wt % based on an initial content of water in Solution A; and B2 is an optical scattering diameter of the amphiphilic polymer in Solution A after a content of water in Solution A is evaporated by an amount of 10 to 30 wt % based on an initial content of water in Solution A.

(2) Another aspect of the present invention includes an ink-jet ink, wherein the amphiphilic polymer is a copolymer prepared from at least two monomers selected from the group consisting of N-acrylic amide, modified vinyl ether and modified vinyl alcohol.

(3) Another aspect of the present invention includes an ink-jet ink, wherein the Stokes diameter of the amphiphilic polymer in Solution A is from 20 nm to 1 μm.

(4) Another aspect of the present invention includes an ink-jet ink, wherein the colorant is a pigment.

(5) Another aspect of the present invention includes an ink-jet ink, wherein the colorant is a dye.

(6) Another aspect of the present invention includes a method of forming an image comprising the step of:

ejecting droplets of the ink-jet ink of the present invention though an ink-jet head onto a plain paper.

(7) Another aspect of the present invention includes a method of forming an image comprising the step of:

ejecting droplets of the ink-jet ink of the present invention though an ink-jet head onto an art paper or a coated paper.

### DESCRIPTION OF THE PREFERRED EMBODIMENT

In the following, the most preferred embodiment to practice this invention will be detailed.

The inventors of this invention, as a result of an extensive study in view of the above problems, have found that an ink-jet ink at least containing a colorant, water, a water-miscible organic solvent and an amphiphilic polymer compound characterized by (1) simultaneously satisfying the conditions defined by aforesaid equations (1), (2) and (3) when a viscosity conversion particle size is A1, an optical particle size is B1, of said hydrophilic/oleophilic polymer compound in solution containing a water-miscible organic solvent and an amphiphilic polymer compound A, and a viscosity conversion particle size is A2, an optical particle size is B2, of said hydrophilic/oleophilic polymer compound when not less than 10 weight % and not more than 30 weight % of water in said solution A has been evaporated; or (2) simultaneously satisfying the conditions defined by aforesaid equations (4), (5) and (6) when a viscosity conversion particle size is A3 and an optical particle size is B3, of the ink, and a viscosity conversion particle size is A4 and an optical particle size is B4, of said hydrophilic/oleophilic polymer compound when not less than 10 weight % and not more than 30 weight % of water in said ink has been evaporated, which led to this invention.

In the following, this invention will be detailed.

An ink-jet ink (hereinafter, also simply referred to as an ink) of this invention contains a colorant, water, water-miscible organic solvent and an amphiphilic polymer compound being both hydrophilic and oleophilic.

An amphiphilic polymer referred to in this invention is a polymer compound provided with a hydrophilic group and a hydrophobic group in a molecule, the molecular weight of which is preferably not less than 300 and not more than 100,000, and the hydrophobic portion and hydrophilic portion are preferably constituted of block copolymer. The molecular weight distribution, a ratio of a weight average molecular weight to a number average molecular weight (Mw/Mn), is preferably 1-4 and more preferably 1-2.5.

Such a amphiphilic polymer compound is preferably at least one type of copolymer selected from N-substituted acrylamide, modified vinyl ether and modified vinyl alcohol. N-substituted acrylamide includes, for example, isopropyl acrylamide, hydrophobic plurane, polyethylene oxide, hydrophilic/oleophilic star-form polymer described in JP-A No. 2002-146256, modified polyvinyl or modified polyvinyl ether described in JP-A Nos. 11-322866, 11-322942, 2000-319473 and 2001-19770, and the form may be any of straight chain polymer, star-form polymer or an emulsion form having a polymer core.

In such a polymer compound group, a relatively hydrophilic segment and a relatively hydrophobic segment coexist in one molecule. On the other hand, in an ink-jet ink, water or a mixed solvent comprising water and an organic solvent can be an ink solvent. Therefore, as for an amphiphilic polymer compound, a mixed solvent primarily comprised of water may become a poor solvent for one segment and may become a good solvent for the other segment.

In this case, the polymer compound is provided with a core portion and a micelle aggregate is formed as if whiskers are grown from the core, or the whisker potion forms an aggregated state in star-form polymer or emulsion, which is provided with a polymer core and hydrophilic/oleophilic polymer of a whisker form (referred to as hair-emulsion), whereby the particle size of hydrophilic/oleophilic polymer will change.

On the other hand, to define a particle size of micro-particles, there are generally several measurement methods and definition methods, and typical ones are a viscosity conversion particle size defined by fluid mechanical viscosity, which is represented by Stokes' particle size, and an optical particle size defined by utilizing optical scattering by micro-particles.

As determination method of a viscosity conversion particle size according to this invention, a particle size can be determined by converting a liquid viscosity based on equation (8) described in Phys. Chem. Chem. Phys., 2000, 2, 1973-1977. Further, it can be also determined according to Einstein-Storks' equation by measuring precipitation rate in a medium, however, in this invention, a viscosity conversion particle size was determined according to the former method.

Further, an optical particle size according to this invention can be determined by a particle size analyzer which is available on the market and employs such as an optical scattering method and a laser Doppler method, and a specific particle size measuring apparatus includes such as laser diffraction type particle size analyzer SLAD 1100, produced by Shimazu Corp., particle size analyzer LA-920 produced by Horiba Ltd. and Zetasizer 1000 produced by Malvan Co., Ltd.

In hydrophilic/oleophilic compounds according to this invention, the above-described viscosity conversion particle size is preferably 20 nm-1 μm with respect to sufficiently exhibiting the aimed effects of this invention, and more preferably 50-500 nm.

In ordinary polymer dispersion or emulsion, the particle size does not change against various external stimuli or the variation directions of the above-defined particle sizes coincide. That is, when an optical particle size becomes large, a viscosity conversion particle size also becomes large.

On the contrary, hydrophilic/oleophilic polymer according to this invention, with respect to the aggregation state or star-form polymer or hair-emulsion, is characterized in that behaviors of the particle sizes are different depending on the state of hydrophilic/oleophilic portions corresponding to various stimuli. That is, when hydrophilic/oleophilic polymer becomes in a dissolved state corresponding to various stimuli, the polymer chain does not contribute any more to an optical particle size but contributes to a viscosity conversion particle size. Therefore, there is a region where behaviors of the both particle size variations are different.

In the neighborhood of a nozzle opening of an ink-jet head, when a water content in ink decreases due to evaporation of water from the top of the nozzle, solubility of the one segment, for which the ink solvent system becomes a relatively poor solvent, decreases, resulting in aggregation while holding a pigment and a polymer compound existing around said segment. However, since the other segment is still in a state of being soluble in the solvent, the dispersion state is maintained. Accordingly, viscosity increase due to evaporation of water content is depressed, so that continuous ejection capability is never disturbed. In particular, to realize ink ejection stability accompanied by evaporation, when water content in ink is evaporated in a range of not less than 10% and not more than 30%, it is indispensable to exhibit a viscosity depressing effect at this evaporation amount of water content. That is, this invention is characterized by the relationships of A1>A2 and B1<B2, when, in solution A containing an amphiphilic polymer compound, a viscosity conversion particle size is A1 and an optical particle size is B1, of said hydrophilic/oleophilic polymer compound; and a viscosity conversion particle size is A2 and an optical particle size is B2, of said hydrophilic/oleophilic polymer compound when not less than 10 weight % and not more than 30 weight % of water in said solution A is evaporated.

This phenomenon is reversible, when ink in a nozzle is stirred by such as ink ejection and the water ratio in the system is recovered to provide a re-dispersed state, clogging due to aggregation is also depressed.

This reversible phenomenon exhibits the most preferable effect with star-form polymer and hair-emulsion in which an aggregation state is depressed.

Further, after ejection, since such as pigment is firstly held by the spread of a hair portion at ink landing and thereafter pigment is fixed on the outermost surface of a recording medium, the phenomenon contributes to such as prevention of feathering and prevention of print through of ink, at recording on ordinary paper.

Further, since an optical particle size decreases by the spread of a hair portion, fixing ability is generated without disturbing coloration of pigment.

The effect such as described above is significant when ratio A1/B1, of viscosity conversion particle size A1 to optical particle size B1, with respect to hydrophilic/oleophilic polymer in ink, is more than 1.

As a colorant utilized in ink of this invention, as an example, water-soluble dye such as acid dye, reactive dye or disperse dye is preferably utilized, and pigment is also preferably utilized.

Water-soluble dye includes acid dye, basic dye and reactive dye.

Preferable examples are as follows.

C.I. Direct Red 2, 26, 31, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, 247,

C.I. Direct Violet 7, 9, 47, 48, 51, 66, 90, 93, 94, 95, 98, 100, 101,

C.I. Direct Yellow 8, 9, 11, 12, 27, 28, 29, 33, 35, 39, 41, 44, 50, 53, 58, 59, 68, 86, 87, 93, 95, 96, 98, 100, 106, 108, 109, 110, 130, 132, 142, 144, 161, 163,

C.I. Direct Blue 1, 10, 15, 22, 25, 55, 67, 68, 71, 76, 77, 78, 80, 84, 86, 87, 90, 98, 106, 108, 109, 151, 156, 158, 159, 160, 168, 189, 192, 193, 194, 199, 200, 201, 202, 203, 207, 211, 213, 214, 218, 225, 229, 236, 237, 244, 248, 249, 251, 252, 264, 270, 280, 288, 289, 291,

C.I. Direct Black 9, 17, 19, 22, 32, 51, 56, 62, 69, 77, 80, 91, 94, 97, 108, 112, 113, 114, 117, 118, 121, 122, 125, 132, 146, 154, 166, 168, 173, 199,

C.I. Acid Red 35, 42, 52, 57, 62, 80, 82, 111, 114, 118, 119, 127, 128, 131, 143, 151, 154, 158, 249, 254, 257, 261, 263, 266, 289, 299, 301, 305, 336, 337, 361, 396, 397,

C.I. Acid Violet 5, 34, 43, 47, 48, 90, 103, 126,

C.I. Acid Yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, 227,

C.I. Acid Blue 9, 25, 40, 41, 62, 72, 76, 78, 80, 82, 92, 106, 112, 113, 120, 127:1, 129, 138, 143, 175, 181, 205, 207, 220, 221, 230, 232, 247, 258, 260, 264, 271, 277, 278, 279, 280, 288, 290, 326,

C.I. Acid Black 7, 24, 29, 48, 52:1, 172,

C.I. Reactive Red 3, 13, 17, 19, 21, 22, 23, 24, 29, 35, 37, 40, 41, 43, 45, 49, 55,

C.I. Reactive Violet 1, 3, 4, 5, 6, 7, 8, 9, 16, 17, 22, 23, 24, 26, 27, 33, 34,

C.I. Reactive Yellow 2, 3, 13, 14, 15, 17, 18, 23, 24, 25, 26, 27, 29, 35, 37, 41, 42,

C.I. Reactive Blue 2, 3, 5, 8, 10, 13, 14, 15, 17, 18, 19, 21, 25, 26, 27, 28, 29, 38,

C.I. Reactive Black 4, 5, 8, 14, 21, 23, 26, 31, 32, 34,

C.I. Basic Red 12, 13, 14, 15, 18, 22, 23, 24, 25, 27, 29, 35, 36, 38, 39, 45, 46,

C.I. Basic Violet 1, 2, 3, 7, 10, 15, 16, 20, 21, 25, 27, 28, 35, 37, 39, 40, 48,

C.I. Basic Yellow 1, 2, 4, 11, 13, 14, 15, 19, 21, 23, 24, 25, 28, 29, 32, 36, 39, 40,

C.I. Basic Blue 1, 3, 5, 7, 9, 22, 26, 41, 45, 46, 47, 54, 57, 60, 62, 65, 66, 69, 71,

C.I. Basic Black 8.

Preferable examples of disperse dyes are as follows. Disperse Yellow 3, 4, 42, 71, 79, 114, 180, 199, 227; Disperse Orange 29, 32, 73; Disperse Red 11, 58, 73, 180, 184, 283, Disperse Violet 1, 26, 48; Disperse Blue 73, 102, 167, 184.

Employed as pigments usable in the present invention may be conventional organic or inorganic pigments known in the art. Examples include azo pigments such as azo lakes, insoluble azo pigments, condensed azo pigments, or chelate azo pigments; polycyclic pigments such as phthalocyanine pigments, perylene and perylene pigments, antharaquinone pigments, quinacridone pigments, dioxazine pigments, thioindigo pigments, iso-indolinone pigments, or quinophtahrony pigments; dye lakes such as basic dye type lakes or acidic dye type lakes; organic pigments such as nitro pigments, nitroso pigments, aniline black, or daylight fluorescent pigments, and inorganic pigments such as carbon black.

Specific organic pigments are exemplified below.

Listed as pigments for magenta or red are C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. and Pigment Red 222.

Listed as pigments for orange or yellow are C.I. are Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128, and C.I. Pigment Yellow 138.

Listed as pigments for green or cyan are C.I. Pigment Blue 15, C.I. Pigment Blue 15:2, C.I. Pigment Blue 15:3, C.I. Pigment Blue 16, C.I. Pigment Blue 60, and C.I. Pigment Green 7.

A content of a colorant in an ink of the present invention is from 1 to 20 weight %.

Pigment employed in ink of this invention is generally dispersed by a dispersion method well known in the art by use of a dispersant, and applicable dispersants include an anionic surfactant, a nonionic surfactant and a water-soluble polymer dispersant.

A water-soluble polymer dispersant preferably utilized in ink of this invention is preferably the following water-soluble resin with respect to ejection stability.

Water-soluble resins preferably utilized include such as styrene-acrylic acid-acrylic acid alkyl ester copolymer, styrene-acrylic acid copolymer, styrene-maleic acid-acrylic acid alkyl ester copolymer, styrene-methacrylic acid copolymer, styrene-mathacrylic acid-acrylic acid alkyl ester copolymer, styrene-maleic acid half ester copolymer, vinyl naphthalene-acrylic-acid copolymer and vinyl naphthalene-maleic acid copolymer.

The content of a water-soluble resin against the total ink is preferably 0.1-10 weight % and more preferably 0.3-5 weight %. These water-soluble resins may also be utilized in combination of at least two types.

Listed as methods for dispersing pigments are those employing various homogenizers such as a ball mill, a sand mill, an attritor, a roller mill, an agitator, a Henschel mixer, a colloid mill, an ultrasonic homogenizer, a pearl mill, a wet system jet mill, or a paint shaker. Further, it is preferable to employ centrifuges and filters to remove the coarse particles in a pigment dispersion.

An average particle size of a pigment in a pigment dispersion is preferably not more than 500 nm, and more preferably not more than 200 nm, still more preferably not more than 100 nm.

Water-soluble organic solvents utilizable in this invention include, for example, alcohols (such as methanol, ethanol, propanol, isopropanol, butanol, isobutanol, secondary butanol, tertiary butanol, pentanol, hexanol, cyclohexanol and benzyl alcohol), polyhydric alcohols (such as ethylene glycol, diethylene glycol, triethylene glycol, polyethylene glycol, propylene glycol, dipropylene glycol, polypropylene glycol, butylene glycol, hexanediol, pentanediol, glycerin, hexanetriol and thiodiglycol), polyhydric alcohol ethers (such as ethylene glycol monomethylether, ethylene glycol monoethylether, ethylene glycol monobutylether, diethylene glycol monomethylether, diethylene glycol monoethylether, diethylene glycol monobutylether, propylene glycol monomethylether, propylene glycol monobutylether, ethylene glycol monomethylether acetate, triethylene glycol monomethylether, triethylene glycol monoethylether, triethylene glycol monobutylether, ethylene glycol monophenylether and propylene glycol monophenylether), amines (such as ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyl diethyltriamine and tetramethyl propylenediamine), amides (such as formamide, N,N-dimethyl formamide and N,N-dimethylacetoamide), heterocyclic rings (such as 2-pyrrolidone, N-methyl-2-pyrrolidone, cyclohexyl pyrrolidone, 2-oxazolidone, 1,3-dimethyl-2-imidazolydinone), sulfoxides (such as dimethylsulfoxide).

Surface active agents usable in the present invention are not particularly limited, listed examples being anionic surface active agents such as dialkylsulfosuccinic acid salts, alkylnaphthalenesulfonic acid salts, or fatty acid salts; nonionic surface active agents such as polyoxyethylene alkyl ethers, polyoxyethylene alkyl allyl ethers, acetylene glycols, or polyoxyethylene-polyoxypropylene block copolymers; and cationic surface active agents such as alkylamines or quaternary ammonium salts.

The above-described surface active agents can be used for dispersing pigments. Of these, particularly preferably employed are anionic surface active agents.

Other than those described above, corresponding to the purpose to enhance various types of performance such as ejection stability, adaptability for printing heads and ink cartridges, storage stability, or image retention properties, if desired, it is possible to incorporate, into the ink-jet ink of the present invention, various additives known in the art such as viscosity modifiers, specific resistance controlling agents, film forming agents, UV absorbers, antioxidants, anti-discoloring agents, fungicides, or anticorrosive agents. Listed as examples may be liquid minute-oil droplets composed of paraffin, dioctyl phthalate, tricresyl phosphate, or silicone oil; UV absorbers described in JP-A Nos. 57-74193, 57-87988, and 62-261476; anti-discoloring agents described in JP-A Nos. 57-74192, 57-87989, 60-72785, 61-146591, 1-95091, and 3-13376; and optical brightening agents described in JP-A Nos. 59-42993, 59-52689, 62-280069, 61-242871, and 4-219266.

In the ink-jet recording method of the present invention, droplets of the ink-jet ink is ejected through an ink-jet head onto an recording material to form an image.

An ink-jet head utilized in an ink-jet recording method employing an ink-jet recording sheet of this invention may be either an on-demand mode or a continuous mode. Further, as an ejection mode, listed as specific examples are such as an electrical-mechanical conversion mode (such as a single cavity type, a double cavity type, a vendor type, a piston type, a share mode type and shared wall type), an electrical-heat conversion mode (such as a thermal ink-jet type and a bubble jet type (registered trade mark)) and an electrostatic suction mode (such as an electrolysis control type and a slit jet type), however, any of ejection modes may be utilized.

Any printing methods can be used for the present invention without any limitation among a serial head method and a line-head method. Among them, the ink of the present invention can be applied to an ink-jet recording method using a line head which should be satisfy the most strict requirement for clogging of an ink-jet head.

In order to most effectively achieve the effects of the present invention, the recording materials should be selected from a plain paper, an art paper and a coated paper.

Widely employed as recording media usable in the recording method employing the ink-jet ink of the present invention may, as an example, be plain paper, coated paper, cast-coated paper, glossy paper, glossy film, OHP film, and exclusive ink-jet paper. Of these, it is possible to exhibit the targeted effects via ink-jet image recording employing plain paper, coated paper, cast-coated paper, or glossy paper, any of which is an absorptive support.

Paper includes coated paper and non-coated paper. Coated paper includes art paper in which the coated amount on one side is approximately 20 g/m², coated paper in which the coated amount on one side is approximately 10 g/m², light weight coated paper in which the coated amount on one side is approximately 5 g/m², ultra light weight coated paper, matte finished coated paper, double tone finished double coated paper, and newsprint paper. Non-coated paper includes printing paper A employing 100 percent chemical pulp, printing paper B employing at least 70 percent chemical pulp, printing paper C employing from 40 to 70 percent chemical pulp, printing paper D employing at most 40 percent chemical pulp, and gravure paper which incorporates mechanical pulp and has been subjected to calendering. More detailed reference will be made to “Saishin Kamikako Binran (Handbbok of Recent Paper Treatments)”, edited by Kako Binran Henshuiinkai Hen, published by Tech Times and “Insatsu Kogaku Binran (Printing Engineering Handbook)”, edited by Nihon Insatsu Gakkai.

Employed as plain paper, are 80-200 μm thick non-coated paper which belongs to a part of non-coated paper sheets, special printing paper sheets, and information sheets. Examples include high quality printing paper, medium quality printing paper, and low quality printing paper, thin printing paper, ultra-thin printing paper, or special printing paper such as high quality colored paper, form paper sheets, PPC sheets, and other kinds such as information sheets. Specifically, available are the paper sheets described below and various modified/treated paper sheets, but the present invention is not limited thereto.

Listed are HIGH QUALITY PAPER, HIGH QUALITY COLORED PAPER, RECYCLED PAPER, COPYING PAPER/COLOR, OCR PAPER, NON-CARBON PAPER/SYNTHETIC PAPER such as UPO 60, 80, and 110 MICRON, or UPOCOAT 70 and 90 MICRON, others such as ONE SIDE ART PAPER 68 kg, COATED PAPER 90 kg, MATTE FORM PAPER 70, 90, and 110 kg, FOAMED PET 38 micron, and MITSUORIKUN (all available from Kobayashi Kirokushi Co., Ltd.), OK HIGH QUALITY PAPER, NEW OK HIGH QUALITY PAPER, SUN FLOWER, PHOENIX, OK ROYAL WHITE, HIGH QUALITY EXPORT PAPER (NPP, NCP, NWP, and ROYAL WHITE), OK BOOK PAPER, OK CREAM BOOK PAPER, CREAM HIGH QUALITY PAPER, OK MAP PAPER, OK ISHIKARI, KYUUREI, OK FORM, OKH, and NIP-N (all available from Shin-Oji Paper Co., Ltd.); KINO, TOKO, EXPORT HIGH QUALITY PAPER, SPECIAL DEMAND HIGH QUALITY PAPER, BOOK PAPER, BOOK PAPER L, PALE CREAM BOOK PAPER, PRIMARY SCHOOL SCIENCE TEXT BOOK PAPER, CONTINUOUS SLIP PAPER, HIGH QUALITY NIP PAPER, GINKAN, KINYO, KINYO (W), BRIDGE, CAPITAL, GINKAN BOOK PAPER, HARP, HARP CREAM, SK COLOR, SECURITY PAPER, OPERA CREAM, OPERA, KYP CARTE, SYLVIA HN, EXCELLENT FORM, and NPI FORM DX (all available from Nippon Paper Co., Ltd.); PEARL, KINRYO, PALE CREAM HIGH QUALITY PAPER, SPECIAL BOOK PAPER, SUPER BOOK PAPER, DIAFORM, and INK-JET FORM (all available from Mitsubishi Paper Mills Ltd.); KINMO V, KINMO SW, HAKUZO, HIGH QUALITY PUBLISHING PAPER, CREAM KINMO, CREAM HAKUZO, SECURITY/TRADABLE COUPON PAPER, BOOK PAPER, MAP PAPER, COPY PAPER, and HNF (all available from Hokuetsu Paper Mills, Ltd.); SIORAI, TELEPHONE DIRECTORY COVER, BOOK PAPER, CREAM SHIORAI, CREAM SHIORAI MEDIUM ROUGH, CREAM SHIORAI HIGH ROUGH, and DSK (all available from Daishowa Paper Manufacturing Co., Ltd.); SENDAI MP HIGH QUALITY PAPER, KINKO, RAICHO HIGH QUALITY, HANGING PAPER, COLORED PAPER BASE PAPER, DICTIONARY PAPER, CREAM BOOK, WHITE BOOK, CREAM HIGH QUALITY PAPER, MAP PAPER, and CONTINUOUS SLIP PAPER (Chuetsu Paper & Pulp Co., Ltd.); OP KINO(CHUETSU), KINSA, REFERENCE PAPER, TRADABLE COUPON PAPER (WHITE)), FORM PRINTING PAPER, KRF, WHITE FORM, COLOR FORM, (K)NIP, FINE PPC, and KISHU INK-JET PAPER (all produced by Kishu Paper Co., Ltd.); TAIOU, BRIGHT FORM, KANT, KANT WHITE, DANTE, CM PAPER, DANTE COMIC, HEINE, PAPER BACKS PAPER, HEINE S, NEW AD PAPER, UTRILLO EXCEL, EXCEL SUPER A, KANTO EXCEL, EXCEL SUPER B, DANTE EXCEL, HEINE EXCEL, EXCEL SUPER C, EXCEL SUPER D, AD EXCEL, EXCEL SUPER E, NEW BRIGHT FORM, and NEW BRIGHT NIP (all available from Daio Paper Corporation) NICHIRIN, GETSURIN, UNREI, GINGA, HAKUUN, WAISU, GETURIN ACE, HAKUUN ACE, and UNKIN ACE (all produced by Japan Paper Industry Co., Ltd.); TAIOU, BRIGHT FORM and BRIGHT NIP (all avaialbew from Nagoya Pulp Co., Ltd.); BOTAN A, KINBATO, TOKU BOTAN, SHIROBOTAN A, SHIROBOTAN C, GINBATO, SUPER SHIROBOTAN A, PALE CREAM SHIROBOTAN, SPECIAL MEDIUM QUALITY PAPER, SHIROBATO, SUPER MEDIUM QUALITY PAPER, AO BATO, AKA BATO, KIN BATO M SNOW VISION, KIN BATO SNOW VISION, SHIRO BATO M, SUPER DX, HANAMASU O, AKA BATO M, and HK SUPER PRINTING PAPER (all manufactured by Honshu Paper Co., Ltd.); STAR LINDEN (A-AW), STAR ELM, STAR MAPLE, STAR LAUREL; STAR POPLAR, MOP, STAR CHERRY I, CHERRY I SUPER, CHERRY II SUPER, STAR CHERRY III, STAR CHERRY IV, CHERRY III SUPER, and CHERRY IV SUPER (all produced by Marusumi Paper Co., Ltd.); SHF (produced by Toyo Pulp Co., Ltd.); and TRP (produced by Tokai Pulp Co., Ltd.).

The representative papers for printing are TOKUHISI ART PAPER (produced by Mitsubishi Paper Mil Co. Ltd.) and OK TOP COAT N (produced by Oji Paper Co. Ltd.)

### EXAMPLE

In the following, this invention will be specifically explained with reference to examples, however, is not limited thereto. Herein, in the examples, expressions of “part(s)” or “%” represent “weight part(s)” or “weight %” respectively, unless otherwise mentioned.

<Preparation of Hydrophilic/Oleophilic Polymer>

[Preparation of Hydrophilic/Oleophilic Polymer A: This Invention]

Styrene of 10 parts, 5 parts of butyl acrylate, 10 parts of 2-hydroxyethyl acrylate and 0.5 parts of ethylene glycol dimethacrylate were mixed to prepare a monomer solution.

Subsequently, after 0.2 parts of dodecyl sulfate and 180 parts of ion-exchanged water were added into a four-necked flask and dissolved, the system was substituted by nitrogen. Into this solution, 5 parts of the above-described monomer solution were added and the resulting solution was heated to 60° C. while stirring. After heating, 3 parts of a 2% ammonium persulfate aqueous solution were titrated and the solution was further heated to 80° C., subsequently the residual monomer solution and 40 parts of a 2% ammonium persulfate aqueous solution were titrated over 6 hours, whereby the core potion was prepared by ripening of 4 hours.

The reacted solution was titrated with a mixed solution of 220 parts of N-isopropyl acrylamide and 1000 parts of ion-exchanged water, and 240 parts a 0.4% ammonium persulfate aqueous solution over 4 hours, while being kept at 80° C., and after 6 hours ripening, coarse particles were eliminated by use of a centrifugal separator, whereby hydrophilic/leophilic polymer A was prepared.

With respect to hydrophilic/Oleophilic polymer A prepared in this manner, viscosity conversion particle size A1 of hydrophilic/oleophilic polymer A in solution A, which was measured according to the latter-mentioned method was 277 nm.

[Preparation of Hydrophilic/Oleophilic Polymer B: This Invention]

Hdrophilic/oleophilic polymer B, which was provided with viscosity conversion particle size A1 of 1030 nm, was prepared in a similar manner to preparation of above-described hydrophilic/oleophilic polymer A except that the addition amount of each additive, the reaction temperature and the reaction time were appropriately adjusted.

[Preparation of Hydrophilic/Oleophilic Polymer C: Comparative Example]

Hdrophilic/oleophilic polymer C was prepared in a similar manner to preparation of above-described hydrophilic/oleophilic polymer A except that the addition amount of N-isopropyl acrylamide was changed to 30 parts.

[Preparation of Hydrophilic/Oleophilic Polymer D: This Invention]

Into a glass vessel equipped with three way stop-cock, added were 20 mmol of methoxyethyl vinyl ether, 20 mmol of ethyl acetate, 0.1 mmol of 1-isobutoxyethyl acetate and 11 ml of toluene, and the system was added with 0.5 mmol of Et_{1.5}AlCl_{1.5} when having been cooled to 0° C., followed by being reacted for 6 hours. Subsequently, after 20 mmol of 2-ethoxyethyl vinyl ether was added and reacted for 4 hours, polymerization reaction was stopped with a 0.3 weight % of ammonia/ethanol solution. The system was diluted with dichloromethane and washed with a 0.6 M/L hydrochloric acid and ion-exchanged water. The obtained organic layer was concentrated by use of an evaporator, dried, and then vacuum dried to prepare hydrophilic/oleophilic polymer D.

[Preparation of Polymer E: Comparative Example]

Polymer E, as a comparative acrylamide hair-emulsion, was prepared in a similar manner to preparation of above-described hydrophilic/oleophilic polymer A except that acrylamide was used instead of N-isopropyl acrylamide.

[Preparation of Polymer F: Comparative Example]

Takelac W-6060 (manufactured by Takeda Chemical Industries Ltd., urethane-type soap-free latex: solid content of 30%, Tg=25° C., mean particle size 150 nm) was utilized as comparative polymer F.

<Characteristic Values of Hydrophilic/Oleophilic Polymer>

[Measurement of Viscosity Conversion Particle Size A1 of Hydrophilic/Oleophilic Polymer Compound]

Each hydrophilic/oleophilic polymer and comparative polymer prepared above was added with the following each additive to prepare solution A, and viscosity conversion particle sizes A1 of hydrophilic/oleophilic polymers and comparative polymers in this solution A were measured according to equation (8) described in Phys. Chem. Chem. Phys., 2000, 2, 1973-1977.

(Solution A)

| | | |
|---|---|---|
| Hydrophilic/oleophilic polymer or comparative polymer | 5 | parts |
| Glycerin | 7 | parts |
| Diethylene glycol | 15 | parts |
| Diethylene glycol monobutyl ether | 2 | parts |
| Olfine E1010 (manufactured by Nisshin Chemical Co., Ltd.) | 0.2 | parts |

The above composition was added with water to make the total volume to 100 parts, whereby solution A, which contains hydrophilic/oleophilic polymer A, was prepared.

[Measurement of Optical Particle Size B1 of Hydrophilic/Oleophilic Polymer Compound]

Optical particle sizes B1 of hydrophilic/oleophilic polymers and comparative polymers in above-described solution A, which contains each hydrophilic/oleophilic polymer and comparative polymer prepared above, were measured by use of Zetasizer 1000 manufactured by Malvan Corp.

[Measurement of Viscosity Conversion Particle Size A2 of Hydrophilic/Oleophilic Polymer Compound]

Each hydrophilic/oleophilic polymer and comparative polymer prepared above was added with the following each additive to prepare solution B, and viscosity conversion particle sizes A2 of hydrophilic/oleophilic polymers and comparative polymers in this solution B were measured according to equation (8) described in Phys. Chem. Chem. Phys., 2000, 2, 1973-1977.

(Solution B)

| | | |
|---|---|---|
| Hydrophilic/oleophilic polymer or comparative polymer | 5 | parts |
| Glycerin | 7 | parts |
| Diethylene glycol | 15 | parts |
| Diethylene glycol monobutyl ether | 2 | parts |
| Olfine E1010 (manufactured by Nisshin Chemical Co., Ltd.) | 0.2 | parts |

The above composition was added with water to make the total volume to 85 parts, whereby solution A, which contains hydrophilic/oleophilic polymer A, was prepared. This solution B is a supposed solution when 15% of water from aforesaid solution A had been evaporated.

[Measurement of Optical Particle Size B2 of Hydrophilic/Oleophilic Polymer Compound]

Optical particle sizes B2 of hydrophilic/oleophilic polymers and comparative polymers in above-described solution B, which contains each hydrophilic/oleophilic polymer and comparative polymer prepared above, were measured by use of Zetasizer 1000 manufactured by Malvan Corp.

The results obtained in the above manner are shown in table 1.

<Preparation of Ink Sets

[Preparation of Pigment Dispersion]

[Preparation of Magenta Pigment Dispersion]

After successively mixing the following additives, the resulting mixture was dispersed by use of a sand grinder, which was filled with zirconia beads of 0.5 mm at a volume ratio of 50%, whereby a magenta pigment dispersion having a pigment content of 10% was prepared. A mean particle size of magenta pigment particles in the obtained pigment dispersion was 83 nm. Herein, the particle size measurement was performed by use of Zetasizer 1000, manufactured by Malvan Corp.

| | | |
|---|---|---|
| C.I. Pigment Red 12 | 15 | parts |
| Jhoncryl 61 (acrylstyrene type resin, manufactured by | 9 | parts |
| Jhonson Co.) | | |
| Glycerin | 15 | parts |
| Ion-exchanged water | 61 | parts |

(Preparation of Black Pigment Dispersion)

Carbon black self dispersion, cabo-jet 300, manufactured by Cabot Co. was diluted with ion-exchanged water to prepare a black pigment dispersion having a pigment content of 10%. The mean particle size of black pigment particles in the obtained pigment dispersion was 153 nm. Herein, the particle size measurement was performed by use of Zetasizer 1000, manufactured by Malvan Corp.

[Preparation of Ink Set 1]

Utilizing the above-prepared magenta pigment dispersion and black pigment dispersion, magenta pigment ink 1 and black pigment ink 1 were prepared by successively adding and mixing the following additives, and were designated as ink set 1.

(Preparation of Magenta Pigment Ink 1)

| | | |
|---|---|---|
| Magenta Pigment Dispersion | 30 | parts |
| Hydrophilic/oleophilic Polymer A | 5 | parts |
| Glycerin | 7 | parts |
| Diethylene glycol | 15 | parts |
| Diethylene glycol monobutyl ether | 2 | parts |
| Olfin E1010 (manufactured by Nisshin Chemical Co., Ltd.) | 0.2 | parts |

The above composition was added with water to make 100 parts, whereby magenta ink 1 was prepared.

(Preparation of Black Pigment Ink 1)

Black pigment ink 1 was prepared in a similar manner to preparation of above-described magenta pigment ink 1, except that a magenta pigment dispersion was replaced by a black pigment dispersion.

[Preparation of Ink Set 2]

Ink set 2 (magenta pigment ink 2/black pigment ink 2) was prepared in a similar manner to preparation of above-described ink set 1 (magenta pigment ink 1/black pigment ink 1), except that hydrophilic/oleophilic polymer A was replaced by hydrophilic/oleophilic polymer D.

[Preparation of Ink Set 3]

Ink set 3 (magenta pigment ink 3/black pigment ink 3) was prepared in a similar manner to preparation of above-described ink set 1 (magenta pigment ink 1/black pigment ink 1), except that hydrophilic/oleophilic polymer A was replaced by hydrophilic/oleophilic polymer B.

[Preparation of Ink Set 4]

Ink set 4 (magenta pigment ink 4/black pigment ink 4) was prepared in a similar manner to preparation of above-described ink set 1 (magenta pigment ink 1/black pigment ink 1), except that hydrophilic/oleophilic polymer A was replaced by hydrophilic/oleophilic polymer C.

[Preparation of Ink Set 5]

Ink set 5 (magenta pigment ink 5/black pigment ink 5) was prepared in a similar manner to preparation of above-described ink set 1 (magenta pigment ink 1/black pigment ink 1), except that hydrophilic/oleophilic polymer A was replaced by hydrophilic/oleophilic polymer E.

[Preparation of Ink Set 6]

Ink set 6 (magenta pigment ink 6/black pigment ink 6) was prepared in a similar manner to preparation of above-described ink set 1 (magenta pigment ink 1/black pigment ink 1), except that hydrophilic/oleophilic polymer A was replaced by hydrophilic/oleophilic polymer F.

[Preparation of Ink Set 7]

Ink set 7 (magenta pigment ink 7/black pigment ink 7) was prepared in a similar manner to preparation of above-described ink set 1 (magenta pigment ink 1/black pigment ink 1), except that hydrophilic/oleophilic polymer A was eliminated and the same amount of ion-exchanged water was added.

[Preparation of Ink Sets 8-14]

Ink sets 8-14 comprising dye ink were prepared in a similar manner to preparation of above-described ink sets 1-7, except that magenta pigment dispersion was replaced by the same amount of a 10% C. I. Acid Red 35 aqueous solution, and black pigment dispersion was replaced by the same amount of a 10% C. I. Direct Black 19 aqueous solution.

<Evaluation of Ink>

[Evaluation of Decap Resistance]

After ejection for continuous 5 days without cleaning was performed under conditions of each ink set being ejected 8 pico liters per 1 drop; by use of a piezo type head having a nozzle opening diameter of 25 μm, a drive frequency number of 12 kHz, a nozzle number of 128 and a nozzle density of 180 dpi; under an environment of 20° C., 30% RH; an ejection state of the nozzle is visually observed to evaluate decap resistance according to the following criteria. Herein, dpi, referred to in this invention, represents a dot number per 2.54 cm.

A: normal ejection from all nozzles,

B: clogging is observed with 1-3 nozzles; however, a normal ejection state is recovered by suction cleaning from the nozzle plane,

C: clogging is observed with 4-10 nozzles; however, a normal ejection state is recovered by suction cleaning from the nozzle plane,

D: clogging is caused with not less than 11 nozzles; or clogging unrecoverable by suction cleaning is caused with at least 1 nozzle,

E: clogging is caused with not less than 20 nozzles; or clogging unrecoverable by suction cleaning is caused with at least 4 nozzles,

In the above evaluation ranks, C and the better ranks are judged to be in an essentially allowable quality range.

[Evaluation of Feathering Resistance]

Black fine lines of 250 μm wide and 5 cm long were printed on ordinary paper (Konicminolta First Class Paper, manufactured by Konicaminolta Business Technology Corp.) with each ink set by use of an on-demand type ink-jet printer, which was equipped with a piezo type head having a nozzle opening diameter of 25 μm, a drive frequency number of 12 kHz, a nozzle number of 128, and a nozzle density of 180 dpi, and which had a maximum recording resolution of 720×720 dpi. A printed state of the black fine lines was visually observed to evaluate feathering resistance according to the following criteria.

A: A fine line is reproduced without thickening due to bleeding.

B: Thickening of the line due to bleeding is not observed, however, ink bleeding along paper fiber is observed at not more than 5 portions.

C: Thickening of the line due to bleeding is not observed, however, ink bleeding along paper fiber is observed at not less than 6 portions and not more than 10 potions.

D: Thickening of the line due to bleeding is observed, and ink bleeding along paper fiber is observed at not less than 11 portions and not more than 20 potions.

E: Significant thickening of the line due to bleeding is observed, and ink bleeding along paper fiber is also observed at not less than 21 portions.

In the above evaluation ranks, C and the better ranks are judged to begin an essentially allowable quality range.

[Evaluation of Bleeding Resistance]

Black fine lines of 100 μm wide were printed on a magenta solid image on ordinary paper (Konicminolta First Class Paper, manufactured by Konicaminolta Business Technology Corp.) with each ink set by use of an on-demand type ink-jet printer, which was equipped with a piezo type head having a nozzle opening diameter of 25 μm, a drive frequency number of 12 kHz, a nozzle number of 128, and a nozzle density of 180 dpi, and which had a maximum recording resolution of 720×720 dpi. A printed state of the fine lines was visually observed to evaluate bleeding resistance according to the following criteria.

A: The boundary line between a fine line (black) and a solid image (magenta) can be clearly recognized.

B: Some slight bleeding portions with boundary lines are recognized by precise observation; however, the quality is not practically problematic at all.

C: Some bleeding portions are recognized with boundary lines; however, the quality is not practically problematic.

D: Strong bleeding with boundary lines are generated to increase the line width by 1.5 times, which is not practically allowable.

E: The boundary between a black fine line and a magenta solid image is not unable to be distinguished. In the above evaluation ranks, C and the better ranks are judged to be a quality in a practically allowable range.

[Evaluation of Image Density]

A black solid image was printed on ordinary paper (Konicminolta First Class Paper, manufactured by Konicaminolta Business Technology Corp.) with each ink set by use of an on-demand type ink-jet printer, which was equipped with a piezo type head having a nozzle opening diameter of 25 μm, a drive frequency number of 12 kHz, a nozzle number of 128, and a nozzle density of 180 dpi, and had a maximum recording resolution of 720×720 dpi. Reflection density of the black image was measured by use of a reflection densitometer, manufactured by X-rite Co., to evaluate image density according to the following criteria.

A: The average density of a black solid image is not less than 1.30.

B: The average density of a black solid image is not less than 1.20 and less than 1.30.

C: The average density of a black solid image is not less than 1.10 and less than 1.20.

D: The average density of a black solid image is not less than 1.00 and less than 1.10.

E: The average density of a black solid image is less than 1.00.

In the above evaluation ranks, C and the better ranks are judged to be a quality in a practically allowable range.

[Evaluation of Fixing Ability]

A state of the image, when a black fine line image prepared in the above feathering resistance evaluation had been rubbed 5 times by a finger 3 minutes after printing, was visually observed to evaluate abrasion resistance according to the following criteria.

A: No changes of a black fine line image are observed at all.

B: Slight abrasion marks are recognized by a precise observation of a black fine line image; however, the quality is not practically problematic at all.

C: Some abrasion marks are recognized in a black fine line image; however, the quality is in a practically allowable region.

D: Many abrasion marks are generated in a black fine line image and density decrease is accompanied therewith, which is not practically allowable.

E: A black fine line image formed on ordinary paper causes peeling, which is out of an allowable quality.

In the above evaluation ranks, C and the better are judged to be a quality within a practically allowable range.

The results obtained above are shown in table 1.

TABLE 1

| | | Amphiphilic polymer, Viscosity conversion particle | | | | | |
|---|---|---|---|---|---|---|---|
| Ink | | size and optical particle size of polymer | | | | | |
| set | Colorant | | A1 | B1 | A2 | B2 | |
| No. | type | Type | (nm) | (nm) | (nm) | (nm) | A1/B1 |
| 1 | Pigment | A | 277 | 185 | 173 | 311 | 1.50 |
| 2 | Pigment | D | 50 | 0 | 24 | 42 | ∞ |
| 3 | Pigment | B | 1030 | 644 | 882 | 956 | 1.60 |
| 4 | Pigment | C | 239 | 230 | 220 | 253 | 1.04 |
| 5 | Pigment | E | 372 | 253 | 407 | 286 | 1.47 |
| 6 | Pigment | F | 312 | 256 | 312 | 256 | 1.22 |
| 7 | Pigment | — | — | — | — | — | — |
| 8 | Dye | A | 277 | 185 | 173 | 311 | 1.50 |
| 9 | Dye | D | 50 | 0 | 24 | 42 | ∞ |
| 10 | Dye | B | 1030 | 644 | 882 | 956 | 1.60 |
| 11 | Dye | C | 239 | 230 | 220 | 253 | 1.04 |
| 12 | Dye | E | 372 | 253 | 407 | 286 | 1.47 |
| 13 | Dye | F | 312 | 256 | 312 | 256 | 1.22 |
| 14 | Dye | — | — | — | — | — | — |

| | Each evaluation results | | | | | |
|---|---|---|---|---|---|---|
| Ink | Decap | | | | | |
| set | resis- | Feathering | Bleeding | Image | Fixing | |
| No. | tance | resistance | resistance | density | ability | Remarks |
| 1 | B | A | A | A | B | Invention |
| 2 | A | A | A | A | A | Invention |
| 3 | C | A | B | B | A | Invention |
| 4 | D | C | C | B | C | Comparison |
| 5 | B | B | D | C | D | Comparison |
| 6 | E | D | D | D | A | Comparison |
| 7 | A | E | E | E | E | Comparison |
| 8 | A | B | A | B | A | Invention |
| 9 | A | A | A | A | A | Invention |
| 10 | B | B | A | B | A | Invention |
| 11 | C | D | E | C | B | Comparison |
| 12 | B | C | E | D | C | Comparison |
| 13 | D | E | E | E | A | Comparison |
| 14 | A | E | E | E | E | Comparison |

TABLE 1(2/2)

| | Each evaluation results | | | | | |
|---|---|---|---|---|---|---|
| | Decap | Feathering | Bleeding | Image | Fixing | |
| Ink set No. | resistance | resistance | resistance | density | ability | Remarks |
| 1 | B | A | A | A | B | Invention |
| 2 | A | A | A | A | A | Invention |
| 3 | C | A | B | B | A | Invention |
| 4 | D | C | C | B | C | Comparison |
| 5 | B | B | D | C | D | Comparison |
| 6 | E | D | D | D | A | Comparison |
| 7 | A | E | E | E | E | Comparison |
| 8 | A | B | A | B | A | Invention |
| 9 | A | A | A | A | A | Invention |
| 10 | B | B | A | B | A | Invention |
| 11 | C | D | E | C | B | Comparison |
| 12 | B | C | E | D | C | Comparison |
| 13 | D | E | E | E | A | Comparison |
| 14 | A | E | E | E | E | Comparison |

It is clear from the results described in table 1 that ink sets comprising inks of this invention, which contain hydrophilic/oleophilic polymer satisfying conditions defined by equations (1), (2) and (3) according to this invention, in contrast to the comparative examples, are excellent in decap resistance; and are superior in feathering resistance, bleeding resistance and fixing ability, as well as can achieve high image density, when being printed on ordinary paper.

Herein, in table 1, described were viscosity conversion particle size A1 and optical particle size B1, of an amphiphilic polymer compound in solution A which contains a water-miscible organic solvent and the hydrophilic/oleophilic polymer compound, and viscosity conversion particle size A2 and optical particle size B2, of an amphiphilic polymer compound when 15 weight % of water in solution A had been evaporated; however, similarly with respect to above described magenta pigment ink, black pigment ink, magenta dye ink and black dye ink, as a result of measuring viscosity conversion particle size A3 and optical particle size B3, of an amphiphilic polymer compound, and viscosity conversion particle size A4 and optical particle size B4, of an amphiphilic polymer compound when 15 weight % of water in ink A had been evaporated, it has been confirmed that any ink set of this invention satisfies equations (4), (5) and (6) according to this invention.

### Example 2

As a result of performing image formation in a similar manner to example 1, except that art paper (Tokuryo, manufactured by Mitsubishi Parper Mills Ltd., basis weight of 127 g/m²) and coated paper for printing (Artpost, basis weigt of 256 g/m², manufactured by Hokuetsu Paper Mills Ltd.) were utilized instead of Konicaminolta First Class Paper (manufactured by Konicaminolta Business Technology Corp.) followed by each evaluation similar to the method described in example 1, it has been confirmed that ink sets comprising inks of this invention, compared to comparative examples, are excellent in decap resistance; and superior in feathering resistance, bleeding resistance and fixing ability, as well as can achieve high image density when being printed on ordinary paper.

What is claimed is:

1. An ink-jet ink comprising:
(i) a colorant;
(ii) Solution A comprising water, a water miscible organic solvent and an amphiphilic polymer,
wherein Solution A satisfies all of the following requirements represented by Schemes (1) to (3):
Scheme (1) A1>A2
Scheme (2) B1>B2
Scheme (3) A1/B1>1
provided that A1 is a Stokes diameter of the amphiphilic polymer in Solution A; B1 is an optical scattering diameter of the amphiphilic polymer in Solution A; A2 is a Stokes diameter of the amphiphilic polymer in Solution A after a content of water in Solution A is evaporated by an amount of 10 to 30 wt % based on an initial content of water in Solution A; and B2 is an optical scattering diameter of the amphiphilic polymer in Solution A after a content of water in Solution A is evaporated by an amount of 10 to 30 wt % based on an initial content of water in Solution A.

2. The ink-jet ink of claim 1, wherein the amphiphilic polymer is a copolymer prepared from at least two monomers selected from the group consisting of N-acrylic amide, modified vinyl ether and modified vinyl alcohol.

3. The ink-jet ink of claim 1, wherein the Stokes diameter of the amphiphilic polymer in Solution A is from 20 nm to 1 μm.

4. The ink-jet ink of claim 1, wherein the colorant is a pigment.

5. The ink-jet ink of claim 1, wherein the colorant is a dye.

6. A method of forming an image comprising the step of:
ejecting droplets of the ink-jet ink of claim 1 though an ink-jet head onto a plain paper.

7. A method of forming an image comprising the step of:
ejecting droplets of the ink-jet ink of claim 1 though an ink-jet head onto an art paper or a coated paper.
